(19) United States
(12) Patent Application Publication
(10) Pub. No.: US 2016/0187453 A1
(43) Pub. Date: Jun. 30, 2016

(54) METHOD AND DEVICE FOR A MOBILE TERMINAL TO LOCATE A SOUND SOURCE

(71) Applicant: ZTE CORPORATION, Shenzhen, Guangdong (CN)

(72) Inventor: Xi Wang, Shenzhen (CN)

(21) Appl. No.: 14/911,477

(22) PCT Filed: Nov. 13, 2013
(86) PCT No.: PCT/CN2013/087065

§ 371 Date: Feb. 11, 2016

(30) Foreign Application Priority Data
Aug. 19, 2013 (CN) 201310360514.3

(51) Int. Cl. G01S 3/808; H04R 1/32; H04R 3/00

(52) U.S. Cl. CPC G01S 3/808; H04R 3/005; H04R 1/326; H04R 2499/11

(57) ABSTRACT

A method and device for a mobile terminal to locate a sound source relates to the technology of localization of a sound source with an array of microphones. The method includes collecting information of an external sound with the array of microphones (101), analysing the information of the external sound to determine information of a target sound source (102), and calculating a location of the target sound source according to time delay of the array of microphones to acquire the information of the target sound source (103). The device includes: a sound source information collection module (20) configured to collect information of an external sound with an array of microphones; a sound source information calculation and processing module (30) configured to analyse the information of the external sound to determine information of a target sound source and calculate a location of the target sound source according to time delay of the array of microphones to acquire the information of the target sound source.

### TECHNICAL FIELD

The present disclosure relates to the technology of localization of a sound source with an array of microphones, and in particular a method and device for a mobile terminal to locate a sound source.

### BACKGROUND

With the popularization of smartphones with advanced configuration and improved functions, mobile phones not only serve as communication tools, but also have more and more functions of other equipment such as laptops and game machines.

Present researches on the localization of a sound source realize the localization of a sound in an immobile place with a fixed dedicated sound source collecting device, which is unable to satisfy requirements of localization of a sound source of ordinary users.

Persons usually determine the location of a sounding object by means of auditory sense. The sound localization mainly includes three factors:

1. distance from a sound source;

2. movement of the sound source;

3. direction of the sound source.

The most important factor influencing the distance from the sound source is loudness. Generally, the loudness of a nearer sound source is larger than that of a farther sound source. Another factor influencing the distance from the sound source is complexity of a sound. In general, the more complex the sound is, the nearer the sounding object is. Since a sound is generally a complex tone which includes tones with different intensities, when the sound source goes farther, tones with lower intensities in the complex tone may become inaudible. The farther the sound source is, the less tones are audible with lower intensities in the complex tone, the complex tone finally being close to a pure tone.

During the propagation of a sound from a sound source to ears of a person, when the person turns his/her head, the distances from the sound source to the ears will change, and tones and intensities of the sound will change differently to the ears. This difference with respect to the ears exists as well even when the person's head does not move, which provides a basis for determining the direction of the sound source.

The distance from the sound source provides a basis for determining movement of the sound source: when the sound source approaches the hearer, the loudness is larger and larger and tends to be complex; when the sound source goes away from the hearer, the loudness is less and less and tends to be simple.

Hardware configuration of present smartphones becomes better and better, the gyroscope, electronic compass and the like have become standard configurations of high-end smartphones. Smartphones with dual-/multi-microphone configuration are also gradually popularized. However, the dual-/multi-microphone in mobile phones are merely used to filter and reduce external noise so as to improve call quality, but not support sound source localization.

The present disclosure, which combines with the principle of localization of a sound source by ears of a person, realizes localization of a specific sound source using mobile terminals such as mobile phones which are currently popularized.

### SUMMARY

The embodiments of the present disclosure are intended to provide a method and device for a mobile terminal to locate a sound source, which can address the problem of localization of a specific sound source implemented by mobile terminals such as mobile phones which are currently popularized.

According to an aspect of the embodiments of the present disclosure, a method for a mobile terminal to locate a sound source is provided, which includes:

collecting information of an external sound with an array of microphones;

analysing the information of the external sound to determine information of a target sound source; and

calculating a location of the target sound source according to time delay of the array of microphones to acquire the information of the target sound source.

Preferably, the array of microphones may include at least two microphones arranged in different locations of a same mobile terminal.

Preferably, the array of microphones may include at least two microphones arranged in different locations of at least two mobile terminals.

Preferably, the step of analysing the information of the external sound to determine information of a target sound source may include:

extracting characteristics of a sound source from the information of the external sound, filtering and de-noising the extracted characteristics of the sound source, so as to obtain information of the sound source comprising a sound intensity and a sound frequency; and

comparing the sound frequency in the information of the sound source with a sound frequency in information of a pre-stored sound source, and when the sound frequency in the information of the sound source matches with the sound frequency in the information of the pre-stored sound source, determining the information of the sound source to be the information of the target sound source.

Preferably, the step of calculating a location of the target sound source according to time delay of the array of microphones to acquire the information of the target sound source may include:

determining the time delay of the array of microphones to acquire the information of the target sound source according to time when the external sound arrives at each microphone in the array of microphones; and

determining the location of the target sound source according to the time delay and the sound intensity.

According to another aspect of the embodiments of the present disclosure, a device for a mobile terminal to locate a sound source is provided, which includes:

a sound source information collection module, configured to collect information of an external sound with an array of microphones;

a sound source information calculation and processing module, configured to analyse the information of the external sound to determine information of a target sound source, and calculate a location of the target sound source according to time delay of the array of microphones to acquire the information of the target sound source.

Preferably, the array of microphones may include at least two microphones arranged in different locations of a same mobile terminal.

Preferably, the array of microphones may include at least two microphones arranged in different locations of at least two mobile terminals.

Preferably, the sound source information calculation and processing module may include:

a sound source analysis sub-module, configured to extract characteristics of a sound source from the information of the external sound, filter and de-noise the extracted characteristics of the sound source, so as to obtain information of the sound source comprising a sound intensity and a sound frequency;

a sound source comparison sub-module, configured to compare the sound frequency in the information of the sound source with a sound frequency in information of a pre-stored sound source; and

sound source determination sub-module, configured to determine the information of the sound source to be the information of the target sound source when the sound frequency in the information of the sound source matches with the sound frequency in the information of the pre-stored sound source.

Preferably, the sound source information calculation and processing module further may include:

a time delay estimation sub-module, configured to determine time delay of the array of microphones to acquire the information of the target sound source according to time when the external sound arrives at each microphone in the array of microphones; and

a sound source localization sub-module, configured to determine the location of the target source according to the time delay and the sound intensity.

The advantageous effects of the embodiments of the present disclosure in comparison with the prior art consist in that:

the embodiments of the present disclosure take full advantage of hardware configuration of mobile terminals such as mobile phones to realize localization of required sound sources, supplementing a technology of localization of a sound source which is currently absent and available to the public, and improving the function and utilisation of mobile terminals such as mobile phones.

### BRIEF DESCRIPTION OF THE DRAWINGS

FIG. 1 is a principle block diagram of a method for a mobile terminal to locate a sound source according to an embodiment of the present disclosure;

FIG. 2 is a block diagram of a device for a mobile terminal to locate a sound source according to an embodiment of the present disclosure;

FIG. 3 is a schematic diagram of the calculation for locating a sound source according to an embodiment of the present disclosure; and

FIG. 4 is a flow chart of the localization of a sound source implemented by a mobile phone according to an embodiment of the present disclosure.

### DETAILED DESCRIPTION

Preferred embodiments of the present disclosure will be described in detail. It should be understood that those preferred embodiments hereafter are merely used to describe and illustrate, but not to limit, the present disclosure.

FIG. 1 is a principle block diagram of a method for a mobile terminal to locate a sound source according to an embodiment of the present disclosure. As shown in FIG. 1, the steps include:

step 101: information of an external sound is collected with an array of microphones.

In said step 101, the array of microphones includes at least two microphones arranged in different locations of a same mobile terminal or in different locations of at least two mobile terminals.

Step 102: the external sound is analysed to determine information of a target sound source.

In said step 102, information of a sound source comprising a sound intensity and a sound frequency is obtained by extracting characteristics of the sound source from the information of the external sound, filtering and de-noising the extracted characteristics of the sound source; and the sound frequency of the information of the sound source is compared with a sound frequency in information of a pre-stored sound source; if the sound frequency in the information of the sound source matches with the sound frequency in the information of the pre-stored sound source, the information of the sound source is determined to be information of the target sound source.

Step 103: a location of the target sound source is calculated according to time delay of the array of microphones to acquire the information of the target sound source.

In said step 103, the time delay of the array of microphones to acquire the information of the target sound source is determined according to time when the external sound arrives at each microphone in the array of microphones, and the location of the target sound source is determined according to the time delay and the sound intensity.

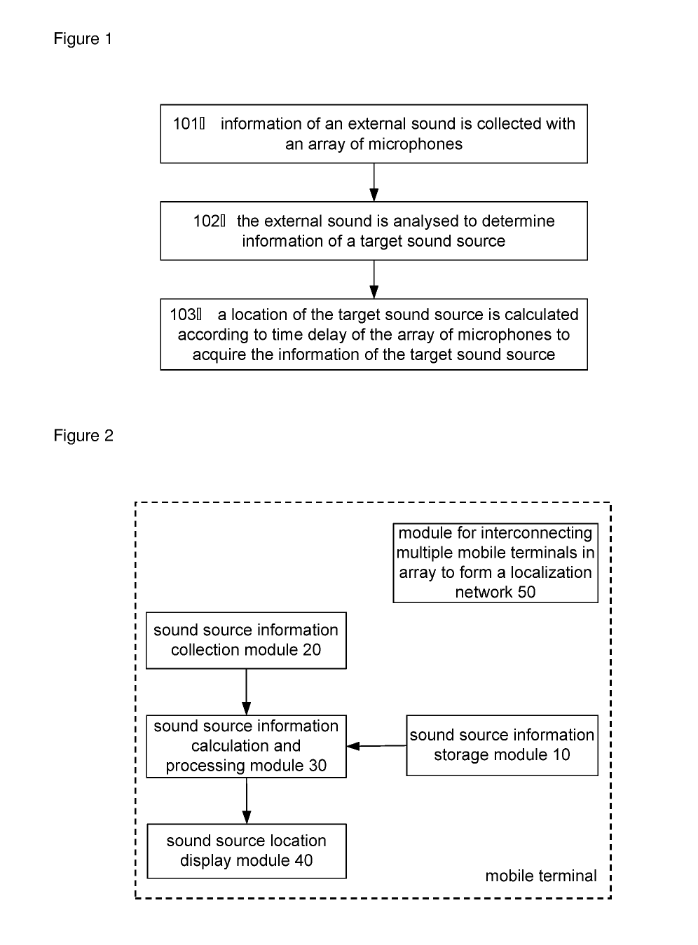

FIG. 2 is a block diagram of a device for a mobile terminal to locate a sound source according to an embodiment of the present disclosure. As shown in FIG. 2, the device includes a sound source information storage module 10, a sound source information collection module 20, a sound source information calculation and processing module 30 and a sound source location display module 40.

The sound source information storage module 10 pre-stores sound source information of a specific sound source, i.e., original data of the specific sound source, and takes the original data of the specific sound source as basic analysis and comparison data for locating a sound source.

After the application for locating a sound source in a mobile terminal is activated, the sound source information collection module 20 collects information of an external sound with an array of microphone. The array of microphones of the sound source information collection module 20 includes at least two microphones which are arranged in different locations of a same mobile terminal or different locations of at least two mobile terminals.

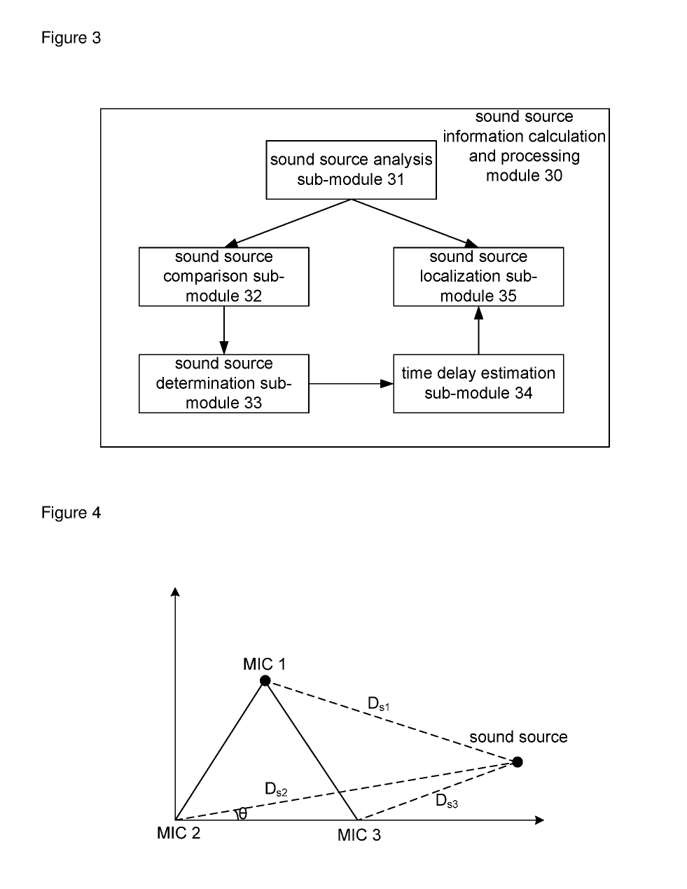

The sound source information calculation and processing module 30 analyses the information of the external sound to determine information of a target sound source, and calculates a location of the target sound source according to time delay of the array of microphones to acquire the information of the target sound source. That is to say, the sound source information calculation and processing module 30 calculates the information of the external sound source acquired by the array of microphones, analyses and compares the information of the external sound source with a pre-stored comparison sound source to determine a location of the sound source. Specifically, as shown in FIG. 3, the sound source information calculation and processing module 30 includes a sound source analysis sub-module 31, a sound source comparison sub-module 32, a sound source determination sub-module 33, a time delay estimation sub-module 34 and a sound source localization sub-module 35. The sound source analysis sub-module 31 extracts characteristics of the sound source from the information of the external sound, filters and de-noises the extracted characteristics of the sound source to obtain information of the sound source comprising a sound intensity and a sound frequency. The sound source comparison sub-module 32 compares the sound frequency in the information of the sound source with a sound frequency in information of the pre-stored sound source. When the sound frequency in the information of the sound source matches with the sound frequency in the information of the pre-stored sound source, the sound source determination sub-module 33 determines that the information of the sound source is information of a target sound source. The time delay estimation sub-module 34 determines time delay of the array of microphones to acquire the information of the target sound source according to time when the external sound arrives at each microphone in the array of microphones. The sound source localization sub-module 35 determines the location of the target source according to the time delay and the sound intensity.

The sound source location display module 40 displays localization information of the location of the sound source on a screen of a mobile terminal according to a result of calculating the acquired information of the external sound source. The whole process for locating the sound source is implemented.

Alternatively, a mobile terminal provided in an embodiment of the present disclosure further includes a module 50 for interconnecting multiple mobile terminals in array to form a localization network. Said module 50 is configured to interconnect mobile terminals to form an array of microphones using mobiles terminals, therefore implementing localization of a sound source.

Above sound source information storage module 10 may be implemented with hardware having a storage function such as a memory in a mobile terminal. The sound source information collection module 20 may be implemented by an array of microphones in the mobile terminal. The sound source calculation and processing module 30 (including the above sub-modules) and the module 50 for interconnecting multiple mobile terminals in array to form a localization network may be implemented by a Central Processing Unit (CPU), a Micro Processing Unit (MPU), a Digital Signal Processor (DSP) or a Field Programmable-Gate Array (FPGA). The sound source location display module 40 may be implemented by hardware having a display function such as a display in the mobile terminal.

The device operates as follows.

In a first step, the characteristics of a specific sound source are needed to be extracted in order to implement localization of the specific sound source. The characteristics of a specific sound source include specific characteristics of the specified sound source, such as a sound frequency, a sound intensity and a sound quality. Original data of the specific sound source is needed to be stored in the sound source information storage module 10. The original data of the specific sound source may be a previous record of the specific sound source.

In a second step, once a function of localization of a sound source is activated in the mobile terminal, the sound source information collection module 20 starts to collect information of an external sound through an array of microphones.

In a third step, the sound source information calculation and processing module 30 in the mobile terminal performs extraction, analysis and comparison on the acquired information of the external sound source, determines information of a target sound source, and further calculates an exact location of the target sound source.

After the information of the target sound source is determined, the principle and implementation of the calculation of the exact location of the target sound source may make reference to the content below.

1. Sounds in different frequencies are analysed to find a specific sound. For example, a sound from the specific sound source is found from a certain environmental noise background.

2. The arrivals of the sound at endpoints of the array of microphone are acquired, i.e., endpoint detection.

3. An auditory system determines the direction and location of the sound source according to a time difference between arrivals of the sound at the endpoints of the array of microphones.

Based on the above mechanism of human auditory perception, a sound source locater is needed to implement noise filtering, endpoint detection and calculation of direction and distance for a sound, wherein

1. the noise filtering and endpoint detection for a sound may be implemented with common algorithms such as a “double-threshold” algorithm and a “wavelet packet threshold” algorithm;

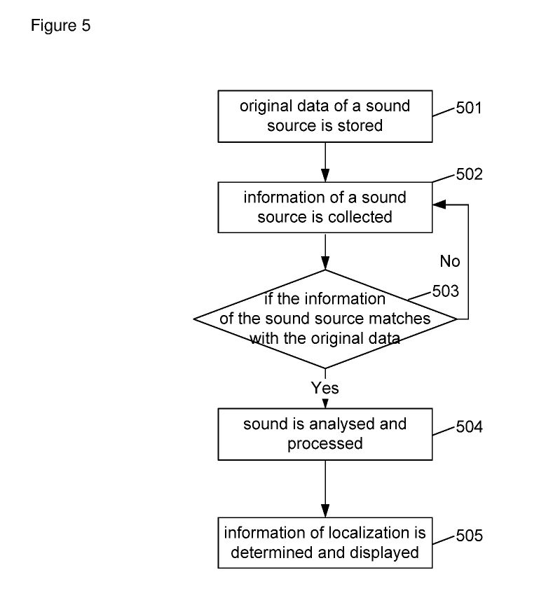

2. the calculation of direction and distance is illustrated based on an example of the diagram of calculation for locating a sound source in FIG. 4. As shown in FIG. 4, the reference model algorithm system uses three microphones which are located at three vertex of an equilateral triangle in a horizontal plane. By means of the endpoint detection, different count values n corresponding to the arrivals of the sound at different microphones may be acquired. Since t=n/f, an estimation of time delay is obtained, where t is travel time of the sound, and f is a sampling frequency. After signal pre-processing is performed at front-end, an algorithm model is established using prior information in the propagation of sound and based on the knowledge of space geometry, which ensures the accuracy of localization meets requirements in application.

FIG. 4 provides only one case. When an array of two, four or more microphones is used for performing localization, provided each microphone in the array of microphones forms a certain angle with the others, the localization may be implemented.

In a fourth step, the sound source location display module 40 displays the location of the target sound source on a screen of the mobile terminal according the exact located location. Specifically, a geographic location may be directly displayed according to a GPS map, or relative azimuthal coordinates may be displayed.

As such, the embodiments of the present disclosure acquire information of a specific sound source via a mobile terminal, performs filtering, analysis and comparison on the sound source with the processing system of the mobile terminal and using a specific algorithm, and then locates the specific sound source according to the time delay of the arrival of the sound at an array of microphones from the sound source.

FIG. 5 is a flow chart of a localization of a sound source implemented by a mobile phone according to an embodiment of the present disclosure. As shown in FIG. 5, the localization of a sound source implemented by a mobile phone includes steps as follows.

In Step 501, a sound source information storage module collects a previous record of a sound source as original data, i.e., original comparison sound source, and stores the original data in a specific location of the memory in the mobile phone.

In Step 502, a sound source information collection module collects information of an external sound source within a certain scope through microphones in the mobile phone.

In Step 503, the collected sound source is compared with the original sound source, if the collected sound source matches with the original sound source, the flow goes to Step 504; otherwise, the flow returns to Step 502.

In Step 504, a sound source information calculation and processing module performs extraction, analysis and comparison on the specific characteristics such as the frequency, intensity and quality of the acquired external sound source, and then calculates an exact location of the target sound source.

In Step 505, a sound source location display module displays the exact location of the sound source on a screen of the mobile phone according to a specific result of the localization.

A software-implemented algorithm may be implemented in an intelligent operating system in the case that the intelligent operating system is used for implementing the localization of a specific sound source. A user may conveniently use a mobile phone in hand to locate a required sound resource. This fills in gaps because there has been no such a device for locating a sound source available to the public, and improves functions and effectiveness of mobile phones.

### Embodiment 1

In an embodiment of the present disclosure, information of an external sound source is collected by a dual-/multi-microphone system of a mobile phone, the dual-/multi-microphone system forming an array of microphones. Extraction of sound intensity and sound frequency, filtering and de-noising, comparison with information of information of a stored sound source are performed on the external sound source to obtain information of a target sound source with a similarity greater than a threshold. A GPS function which is a standard function of smart phones at present is combined for implementing localization of the target sound source.

### Embodiment 2

In an embodiment of the present disclosure, multiple mobile phones may be used for collecting information of an external sound source. Here, each of the mobile phones functions as a microphone, and the mobile phones form an array of microphones. With the GPS function of the mobile phones, as well as the Wi-Fi Direct function and/or Packet Switch (PS) domain interconnection function for interconnecting the mobile phones, a more powerful localization array network is formed, so as to implement localization of a target sound source in a larger scope. In other words, in the embodiments of the present disclosure, GPS, Wi-Fi Direct and PS domain interconnection are used for interconnecting multiple mobile phones, forming a network localization system with an array of microphones of mobile phones, further improving the scope and function of localization of a sound source.

From the above, the technical effects of the embodiments of the present disclosure are as follows:

according to the embodiments of the present disclosure which do not require additional active transmitting devices such as a RF device and a ultrasound device, a specific sound source may be located with intrinsic microphone system of a mobile terminal in combination with the principle of acoustic localization, which may be used in different situations, for example, localization of missing children, criminals or other dangerous goods.

The present disclosure has been described in detail, but the present disclosure is not limited to the above description. Those skilled in the art can make various modifications according to the principle of the present disclosure. Thus, it should be understood that any modification according to the principle of the present disclosure falls within the protection scope of the present disclosure.

1. A method for a mobile terminal to locate a sound source, comprising:
collecting information of an external sound with an array of microphones;
analysing the information of the external sound to determine information of a target sound source; and
calculating a location of the target sound source according to time delay of the array of microphones to acquire the information of the target sound source.

2. The method according to claim 1, wherein the array of microphones comprises at least two microphones arranged in different locations of a same mobile terminal.

3. The method according to claim 1, wherein the array of microphones comprises at least two microphones arranged in different locations of at least two mobile terminals.

4. The method according to claim 1, wherein the step of analysing the information of the external sound to determine information of a target sound source comprises:
extracting characteristics of a sound source from the information of the external sound, filtering and de-noising the extracted characteristics of the sound source, so as to obtain information of the sound source comprising a sound intensity and a sound frequency; and
comparing the sound frequency in the information of the sound source with a sound frequency in information of a pre-stored sound source, and when the sound frequency in the information of the sound source matches with the sound frequency in the information of the pre-stored sound source, determining the information of the sound source to be the information of the target sound source.

5. The method according to claim 4, wherein the step of calculating a location of the target sound source according to time delay of the array of microphones to acquire the information of the target sound source comprises:
determining the time delay of the array of microphones to acquire the information of the target sound source according to time when the external sound arrives at each microphone in the array of microphones; and
determining the location of the target sound source according to the time delay and the sound intensity.

6. A device for a mobile terminal to locate a sound source, comprising:
a sound source information collection module, configured to collect information of an external sound with an array of microphones;
a sound source information calculation and processing module, configured to analyse the information of the external sound to determine information of a target sound source, and calculate a location of the target sound source according to time delay of the array of microphones to acquire the information of the target sound source.

7. The device according to claim 6, wherein the array of microphones comprises at least two microphones arranged in different locations of a same mobile terminal.

8. The device according to claim 6, wherein the array of microphones comprises at least two microphones arranged in different locations of at least two mobile terminals.

9. The device according to claim 6, wherein the sound source information calculation and processing module comprises:
a sound source analysis sub-module, configured to extract characteristics of a sound source from the information of the external sound, filter and de-noise the extracted characteristics of the sound source, so as to obtain information of the sound source comprising a sound intensity and a sound frequency;
a sound source comparison sub-module, configured to compare the sound frequency in the information of the sound source with a sound frequency in information of a pre-stored sound source; and
sound source determination sub-module, configured to determine the information of the sound source to be the information of the target sound source when the sound frequency in the information of the sound source matches with the sound frequency in the information of the pre-stored sound source.

10. The device according claim 9, wherein the sound source information calculation and processing module further comprises:
a time delay estimation sub-module, configured to determine the time delay of the array of microphones to acquire the information of the target sound source according to time when the external sound arrives at each microphone in the array of microphones; and
a sound source localization sub-module, configured to determine the location of the target source according to the time delay and the sound intensity.

11. The method according to claim 2, wherein the step of analysing the information of the external sound to determine information of a target sound source comprises:
extracting characteristics of a sound source from the information of the external sound, filtering and de-noising the extracted characteristics of the sound source, so as to obtain information of the sound source comprising a sound intensity and a sound frequency; and
comparing the sound frequency in the information of the sound source with a sound frequency in information of a pre-stored sound source, and when the sound frequency in the information of the sound source matches with the sound frequency in the information of the pre-stored sound source, determining the information of the sound source to be the information of the target sound source.

12. The method according to claim 3, wherein the step of analysing the information of the external sound to determine information of a target sound source comprises:
extracting characteristics of a sound source from the information of the external sound, filtering and de-noising the extracted characteristics of the sound source, so as to obtain information of the sound source comprising a sound intensity and a sound frequency; and
comparing the sound frequency in the information of the sound source with a sound frequency in information of a pre-stored sound source, and when the sound frequency in the information of the sound source matches with the sound frequency in the information of the pre-stored sound source, determining the information of the sound source to be the information of the target sound source.

13. The method according to claim 11, wherein the step of calculating a location of the target sound source according to time delay of the array of microphones to acquire the information of the target sound source comprises:
determining the time delay of the array of microphones to acquire the information of the target sound source according to time when the external sound arrives at each microphone in the array of microphones; and
determining the location of the target sound source according to the time delay and the sound intensity.

14. The method according to claim 12, wherein the step of calculating a location of the target sound source according to time delay of the array of microphones to acquire the information of the target sound source comprises:
determining the time delay of the array of microphones to acquire the information of the target sound source according to time when the external sound arrives at each microphone in the array of microphones; and
determining the location of the target sound source according to the time delay and the sound intensity.

15. The device according to claim 7, wherein the sound source information calculation and processing module comprises:
a sound source analysis sub-module, configured to extract characteristics of a sound source from the information of the external sound, filter and de-noise the extracted characteristics of the sound source, so as to obtain information of the sound source comprising a sound intensity and a sound frequency;
a sound source comparison sub-module, configured to compare the sound frequency in the information of the sound source with a sound frequency in information of a pre-stored sound source; and
sound source determination sub-module, configured to determine the information of the sound source to be the information of the target sound source when the sound frequency in the information of the sound source matches with the sound frequency in the information of the pre-stored sound source.

16. The device according to claim 8, wherein the sound source information calculation and processing module comprises:
a sound source analysis sub-module, configured to extract characteristics of a sound source from the information of the external sound, filter and de-noise the extracted characteristics of the sound source, so as to obtain information of the sound source comprising a sound intensity and a sound frequency;
a sound source comparison sub-module, configured to compare the sound frequency in the information of the sound source with a sound frequency in information of a pre-stored sound source; and
sound source determination sub-module, configured to determine the information of the sound source to be the information of the target sound source when the sound frequency in the information of the sound source matches with the sound frequency in the information of the pre-stored sound source.

17. The device according claim 15, wherein the sound source information calculation and processing module further comprises:
a time delay estimation sub-module, configured to determine the time delay of the array of microphones to acquire the information of the target sound source according to time when the external sound arrives at each microphone in the array of microphones; and
a sound source localization sub-module, configured to determine the location of the target source according to the time delay and the sound intensity.

18. The device according claim 16, wherein the sound source information calculation and processing module further comprises:
a time delay estimation sub-module, configured to determine the time delay of the array of microphones to acquire the information of the target sound source according to time when the external sound arrives at each microphone in the array of microphones; and
a sound source localization sub-module, configured to determine the location of the target source according to the time delay and the sound intensity.
